(19) United States
(12) Patent Application Publication
(10) Pub. No.: US 2005/0242139 A1
(43) Pub. Date: Nov. 3, 2005

(54) Structure stroller basket

(76) Inventor: Hsing Li, Taichung (TW)

Correspondence Address: RABIN & BERDO, P.C., Suite 500, 1101 14th Street, N.W., Washington, DC, 20005, US

(21) Appl. No.: 10/834,260

(22) Filed: Apr. 29, 2004

(51) Int. Cl. B62B 7/00; B62B 9/00; B60R 7/00; B60R 9/00

(52) U.S. Cl. 224/409; 224/585; 224/417; 224/431

(57) ABSTRACT

An improved structure stroller basket in which two arcuate notches are formed in the frame-like rim extending outward from the opening of the basket. As such, the basket is fitted onto the back rod frame of the stroller seat and retained in position with the basket bottom resting against the chassis axle. Furthermore, a hole is disposed in each of the two sides of the basket opening such that the short posts postured inward from the two ends of a U-shaped handle enter the holes and become pivotably coupled. As such, since the arcuate notches in the rim of the basket and the back rod frame of the stroller seat are positioned together by direct insertion, both assembly component quantity and finishing time are reduced and, furthermore, the potentially hazardous incidence of shoes lace snagging is eliminated to thereby effectively achieve the practical utility of fast, convenient, and simple installation.

### BACKGROUND OF THE INVENTION

1) Field of the Invention

The invention herein relates to an improved structure stroller basket, wherein since the arcuate notches in the rim of the said basket and the back rod frame of the stroller seat are positioned together by direct insertion, both assembly component quantity and finishing time are reduced to thereby effectively achieve fast, convenient, and simple installation and, furthermore, afford the additional practical utility of functioning as a standalone basket with a handle.

2) Description of the Prior Art

Numerous conventional strollers structures and exterior shapes have been developed which not only emphasize ease of child operation and necessary safety considerations but at the same time observable practical designs that facilitate practical usage by adults and older children. For example, an assistive steering handlebar disposed at the rear of the stroller controls a handlebar at the front that also can steer the stroller, thereby inducing seated children to become absorbed in stroller directional control. Additionally, to enable children placement of their handheld toys on the stroller and occasional play with them, a basket B is often installed at the rear of the stroller A (as shown in FIG. 1-A and FIG. 1-B), wherein holes are formed in the bottom of the basket and, after a mounting plate C is situated around the axle A1, bolts D are inserted through the basket bottom and the mounting plate C, and nuts D1 are fastened onto them. However, this results in mandatory modifications to the basket B forming die as well as increases the quantity of bolts D and nuts D1 used and, furthermore, additionally considering mounting plate C development and installation, the above factors lead to higher manufacturer production costs. Moreover, since there are bolts D, shoelaces E snagged on them can cause tripping (as shown in FIG. 1-B) and poses a potential hazard to the person at the rear.

### SUMMARY OF THE INVENTION

The applicant of the invention herein analyzed and researched the above situation based on long-term observation which culminated in the submittal of the patent application of the present invention.

The primary objective of the invention herein is to provide an improved structure stroller basket in which two arcuate notches are formed in the frame-like rim extending outward from the opening of the basket; as such, the basket is fitted onto the back rod frame of the stroller seat and retained in position with the basket bottom resting against the chassis axle; furthermore, a hole is disposed in each of the two sides of the basket opening such that the short posts postured inward from the two ends of a U-shaped handle enter the holes and become pivotably coupled; as such, since the arcuate notches in the rim of the said basket and the back rod frame of the stroller seat are positioned together by direct insertion, both assembly component quantity and finishing time are reduced and, furthermore, the potentially hazardous incidence of shoes lace snagging is eliminated to thereby effectively achieve fast, convenient, and simple installation and, furthermore, afford the additional practical utility of functioning as a standalone basket with a handle.

### BRIEF DESCRIPTION OF THE DRAWINGS

FIG. 1-A is an isometric drawing of a conventional structure.

FIG. 1-B is an orthographic drawing of the conventional structure following installation.

FIG. 2 is an exploded drawing of structure of the invention herein.

FIG. 3-A is an orthographic drawing of invention herein preparatory to installation.

FIG. 3-B is an orthographic drawing of invention herein following installation.

FIG. 4 is an isometric drawing the invention herein following installation.

FIG. 5 is an orthographic drawing of the invention herein following installation.

FIG. 6 is an isometric drawing of another embodiment of the invention herein.

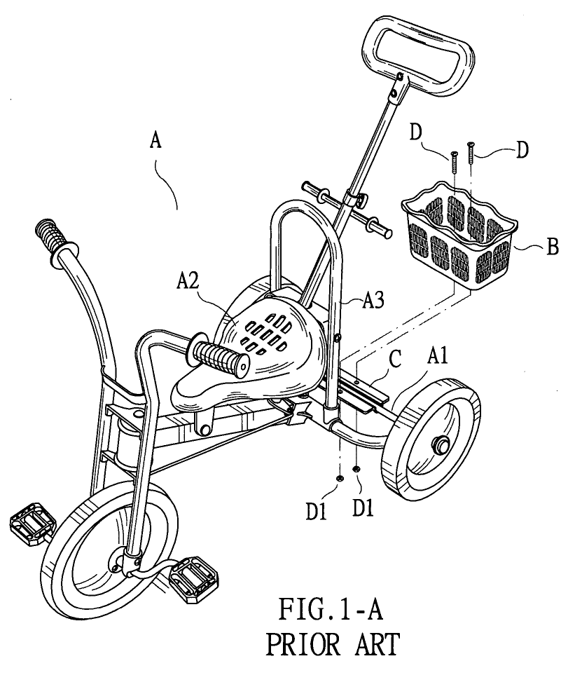

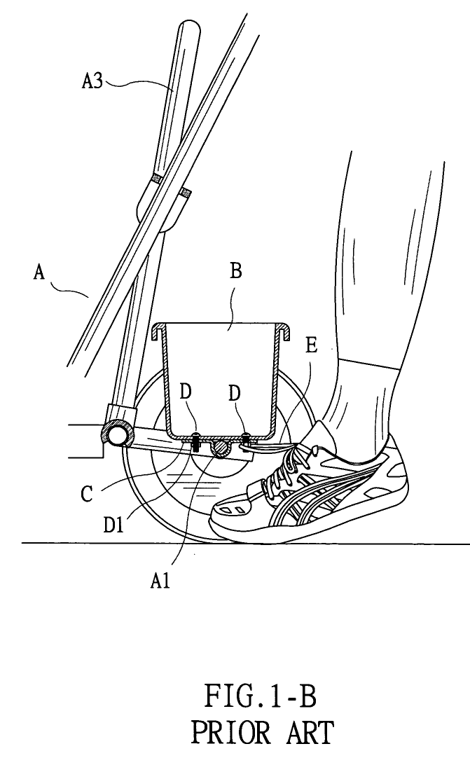

### DETAILED DESCRIPTION OF THE INVENTION

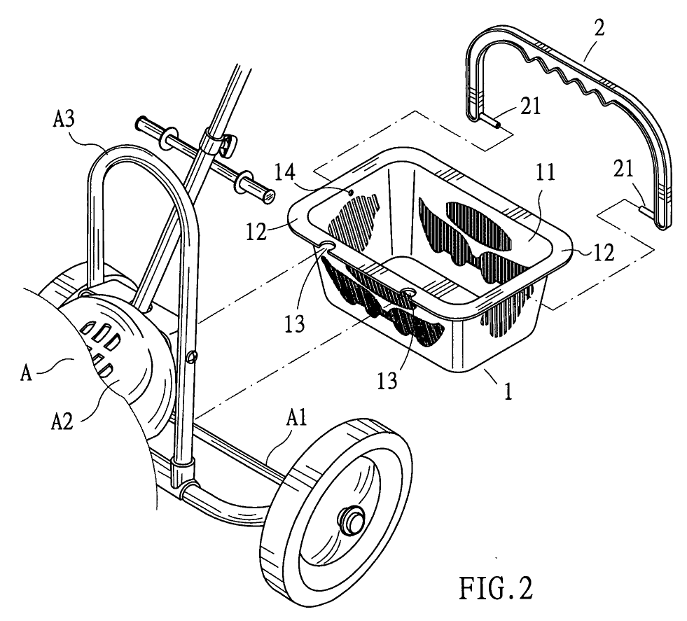

Referring to FIG. 2, the improved structure stroller basket of the invention herein further improves the assembly and mounting of the basket installed behind the back rod frame in the stroller seat because two arcuate notches 13 are formed in the frame-like rim 12 extending outward from the opening 11 of the basket 1 and, furthermore, a hole 14 is disposed in each of the two sides of the basket 1 opening 11 such that the short posts 21 postured inward from the two ends of a U-shaped handle 2 enter the holes 14 and become pivotably coupled.

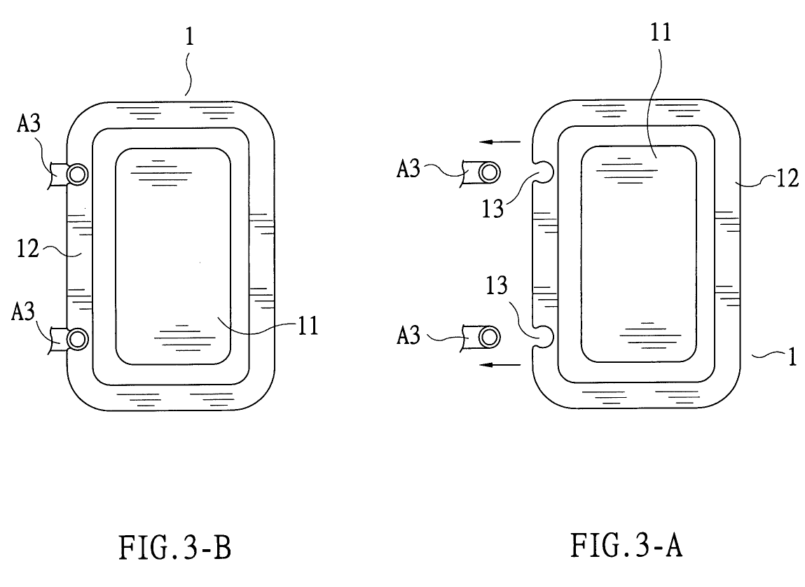

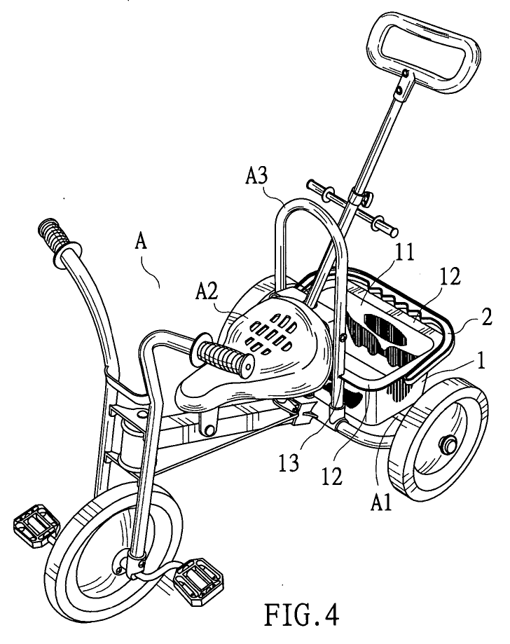

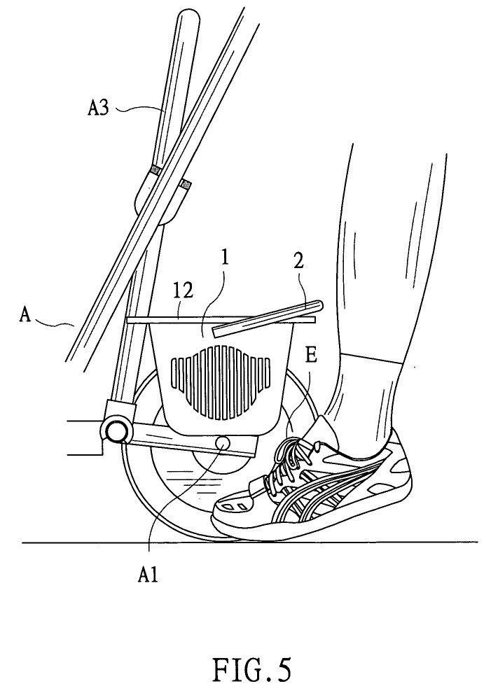

As such, the basket 1 is fitted onto the back rod frame A3 of the stroller A seat A2 and retained in position (as shown in FIG. 3-A and FIG. 3-B) with the basket bottom resting against the chassis axle A1 (as shown in FIG. 4 and FIG. 5); as a result, since the arcuate notches 13 in the rim 12 of the said basket 1 and the back rod frame A3 of the stroller A seat A2 are positioned together by direct insertion, bolts and nuts are not required, special attention in advance of basket 1 die design changes is unnecessary, and since a mounting plate C such as that in prior art is not utilized, there are no special considerations involved which, of course, results in zero production cost increase problems for manufacturers.

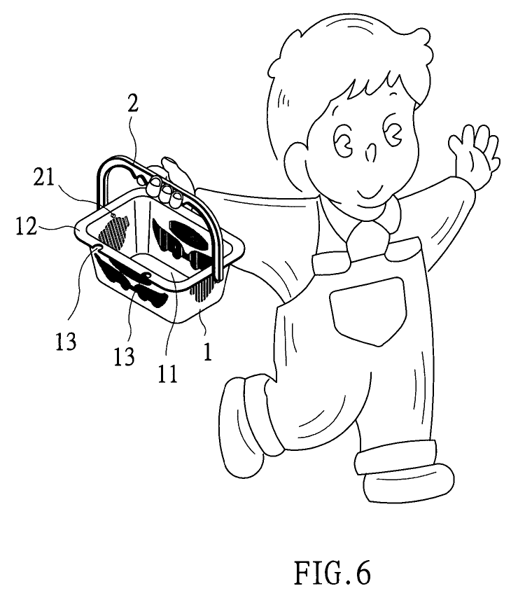

At the same time, since bolt protrusion is precluded (as shown in FIG. 5), the potentially hazardous incidence of shoes lace E snagging on them is eliminated. Furthermore, if required, basket 1 detachment from the chassis A can be accomplished with less strength and the handle 2 raised to constitute a carrying basket (as shown in FIG. 6) that can be played with by children.

In summation of the foregoing section, since the invention herein is fast, convenient, and simple to install and also has the practical utility of functioning as a standalone basket with a handle and, furthermore, thereby meets the new patent application requirements stipulated in Article 97 of the Patent Law, the present invention is lawfully submitted to the patent bureau for review and the granting of the commensurate patent rights.

1. An improved structure stroller basket that further improves the assembly and mounting of the basket installed behind the back rod frame in the stroller seat because two arcuate notches are formed in the frame-like rim extending outward from the opening of the said basket; as such, since the said arcuate notches in the said rim of the said basket and the back rod frame of the said stroller seat are positioned together by direct insertion, both assembly component quantity and finishing time are reduced and, furthermore, the potentially hazardous incidence of shoes lace snagging is eliminated to thereby effectively achieve the practical utility of fast, convenient, and simple installation.

2. As mentioned in claim 1 of the improved structure stroller basket invention herein, the said basket has a hole is disposed in each of the two sides of its said opening such that short posts postured inward from the two ends of a U-shaped handle enter the said holes and become pivotably coupled.
